(19) United States
(12) Patent Application Publication
(10) Pub. No.: US 2018/0340609 A1
(43) Pub. Date: Nov. 29, 2018

(54) METHOD FOR CONTROLLING A HYDROSTATIC DRIVE

(71) Applicant: Robert Bosch GmbH, Stuttgart (DE)

(72) Inventors: Paul Zeman, Wien (AT); Adrian Trachte, Stuttgart (DE); Daniel Seiler-Thull, Stuttgart (DE); Peter Altermann, Stuttgart (DE); Andreas Kugi, Wien (AT); Wolfgang Kemmetmueller, Wien (AT)

(21) Appl. No.: 15/989,341

(22) Filed: May 25, 2018

(30) Foreign Application Priority Data
May 29, 2017 (DE) 10 2017 208 988.1

(51) Int. Cl. F16H 61/42; B60K 17/10; F16H 39/06; F16H 47/02

(52) U.S. Cl. CPC F16H 61/42; B60K 17/10; F16H 2059/147; F16H 47/02; F16H 39/06

(57) ABSTRACT

A method for controlling a hydrostatic drive, which has a driving engine, a hydraulic pump coupled to the driving engine and a hydraulic motor coupled to the hydraulic pump by way of a pressurized hydraulic work line, includes calculating a manipulated variable vector comprising at least one manipulated variable for the hydrostatic drive based on (i) an output torque setpoint value for a torque on a secondary shaft driven by the hydraulic motor, (ii) a rotational speed and torque of the driving engine emerging from a predetermined operating point characteristic for the driving engine, and (iii) volumetric and mechanical losses of at least one adjuster unit comprising the hydraulic pump and the hydraulic motor. The manipulated variable vector is used to control the hydrostatic drive.

This application claims priority under 35 U.S.C. § 119 to patent application no. DE 10 2017 208 988.1, filed on May 29, 2017 in Germany, the disclosure of which is incorporated herein by reference in its entirety.

The present disclosure relates to a method for controlling a hydrostatic drive, in particular a travel drive, and a computing unit and a computer program for the implementation thereof.

### BACKGROUND

In hydrostatic drives, a hydraulic pump is driven by a driving engine, usually a combustion engine, for example a diesel motor. By way of the hydraulic pump, one or more hydraulic motors (for rotational movements), hydraulic cylinders (for linear movements) and optionally valves, or the like, for implementing functions such as work and drive functions connected therewith (e.g., in an open or closed hydraulic circuit) are driven. By way of example, for a drive function, a hydraulic motor drives one or more wheels or similar and it is itself driven by the hydraulic pump in the process. Hydrostatic travel drives are often found, for example, in mobile machines, i.e., machines with a travel drive, such as, e.g., agricultural machines, diggers, mobile cranes, transhipment machinery, communal vehicles, compact loaders, forklift trucks, pushback tugs, etc. At least the hydraulic motors are usually embodied as adjuster elements, i.e. as having an adjustable work volume.

It is possible to use a power split after the driving engine, in which a mechanical power path is installed parallel to the hydrostatic part, in order to increase the efficiency of the drivetrain.

Originally, hydrostatic drives were actuated mechanically or hydraulically. Here, an operating element is usually assigned to each manipulated variable. Many of the electronically actuated systems employed these days have adopted this actuation concept and map the operating part prescriptions onto manipulated variables, usually directly with a one-to-one assignment.

By way of example, DE 10 2010 020 004 A1 has disclosed an actuation in which a torque feedback control is realized on a pump shaft within the meaning of a power or torque regulator. To this end, a capacity of the pump is set by way of a final control device.

DE 10 2014 224 337 A1 has disclosed, from a predetermined setpoint value for a pressure in the hydraulic work circuit, a rotational speed of the hydraulic pump or an output variable of the hydrostatic drive within the scope of a feedforward control, to ascertain and set at least one of the plurality of manipulated variables of the hydrostatic drive and automatically update the remaining control variables and/or manipulated variables.

### SUMMARY

According to the disclosure, a method for controlling a hydrostatic drive, in particular a travel drive, and a computing unit and computer program to carry this out are proposed, having the features disclosed herein. Advantageous configurations are the subject matter of the dependent claims and the following description.

The disclosure develops a regulation strategy allowing a driver desired torque to be impressed on a secondary shaft that is driven by the hydraulic motor or hydraulics-based motor, said secondary shaft being connected to drive wheels, for example. To this end, up to three manipulated variables are available, namely the drive torque of the driving engine (e.g. combustion engine), and the two adjustable volumes of the hydraulic adjuster units (i.e., conveying volume of the hydro-pump and displacement volume of the hydro-engine) or, in principle, a transmission ratio between hydraulic pump and hydraulic engine. A substantial advantage of the disclosure consists in being able to reduce the power losses of the drive occurring in the system. At the same time, it is possible to take account of the manipulated variable limits of the system, in particular in the form of the maximum torque of the driving engine and/or the restricted adjustable volumes.

An essential component of the employed multivariable regulation is formed by the generation of stationary-ideal work points, at which the power losses in the system are minimized. Here, the goal is to operate the driving engine on the operating point curve (i.e., torque/rotational speed pairs) of ideal effectiveness (the so-called “operation line”, usually close to the full-load curve in the case of combustion engines) and, at the same time, minimize the power losses as a consequence of volumetric and mechanical losses in the hydraulic adjuster units. The ideal operating points form the basis for a multivariable regulation of the measured pressure and rotational speed system variables. The over-actuated system structure permits systematic taking account of the manipulated variable limits in the regulator design.

Preferably, proceeding from a quasi-static feedforward control, use is preferably made in a preferred development of the disclosure of a dynamic feedforward control for improving the response to setpoint changes in the case of highly dynamic torque requirements. In a further preferred development of the disclosure, a stabilizing regulator is used in order to compensate parameter variations and suppress non-modeled disturbances.

A computing unit according to the disclosure, for example a controller of a hydrostatic drive, is configured to carry out a method according to the disclosure, in particular by programming means.

The implementation of the method in the form of a computer program, too, is advantageous as this incurs particularly low costs, particularly if an implementing controller is also used for further tasks and therefore present in any case. Suitable data media for providing the computer program are, in particular, magnetic, optical and electrical storage units, such as, e.g., hard disk drives, flash memories, EEPROMs, DVDs, and many more. Downloading a program via computer networks (Internet, intranet, etc.) is also possible.

The disclosure can be used for a hydraulic drive, in particular a travel drive, having a driving engine (e.g., a combustion engine), a primary variable capacity pump and a secondary control motor. The drive can have a serial or power split topology. The hydraulic circuit can be open or closed. In particular, the disclosure can be used for a hydraulic travel drive in automobiles (hydraulic hybrid vehicles: “hydraulic powertrain” or “hydraulic hybrid vehicle”) or mobile machines.

Further advantages and configurations of the disclosure emerge from the description and the attached drawing.

It is understood that the features mentioned above and the features yet to be explained below can be used not only in the respectively specified combination, but also in other combinations or on their own, without departing from the scope of the present disclosure.

The disclosure is illustrated schematically on the basis of an exemplary embodiment in the drawing and described in detail below with reference to the drawing.

### BRIEF DESCRIPTION OF THE DRAWINGS

FIG. 1 schematically shows a model of a power split drivetrain with a combustion engine, planetary transmission and hydraulic adjuster units.

FIG. 2 shows the basic structure of a control loop according to a preferred embodiment of the disclosure.

FIG. 3 shows a typical torque map of a combustion engine.

FIG. 4 shows manipulated variables arising according to a preferred embodiment of the disclosure, as a function of the travel speed.

FIG. 5 shows graphs illustrating an acceleration process of a drivetrain actuated according to a preferred embodiment of the disclosure.

### DETAILED DESCRIPTION

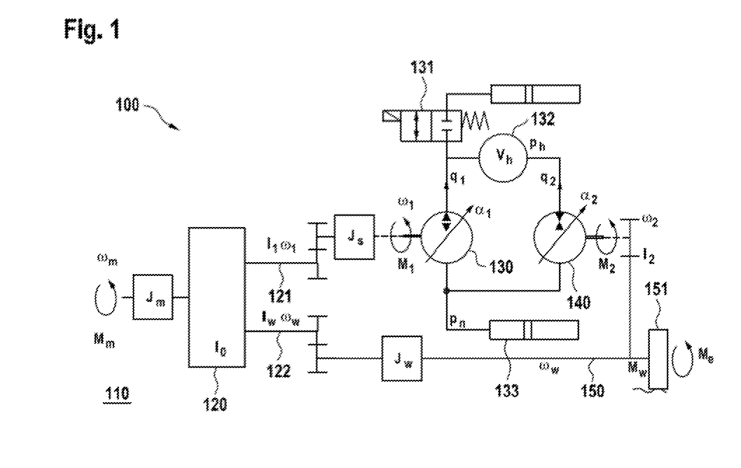

FIG. 1 schematically shows a model of a power split drivetrain 100, as may underlie the disclosure. By way of example, the drivetrain 100 is a traveling drivetrain and has a driving engine embodied as a combustion engine 110, for example, which is followed by a power split transmission that is embodied here as a planetary transmission 120. The power split transmission has a secondary shaft 121 for a hydrostatic power branch and a secondary shaft 122 for a mechanical power branch.

The secondary shaft 122 is connected to one or more wheels 151 by way of a transmission and a secondary shaft 150.

The secondary shaft 121 is connected via a transmission to a hydraulic pump 130 that is embodied as an adjuster unit with an adjustable capacity V₁. The hydraulic pump 130 is connected to the hydraulic motor 140 that is embodied as an adjuster unit with adjustable displacement volume V₂ via a high-pressure line 132 (secured by means of a pressure release valve 131) and via a low-pressure line (with a low-pressure reservoir or tank 133). By way of a transmission, the hydraulic motor 140 is likewise connected to the secondary shaft 150.

Overall, a drive torque M_{w} emerges at the secondary shaft 150 by specifying the drive torque Mₘ of the driving engine 110 and the adjustable volumes V₁, V₂ of the pump 130 and of the motor 140, respectively.

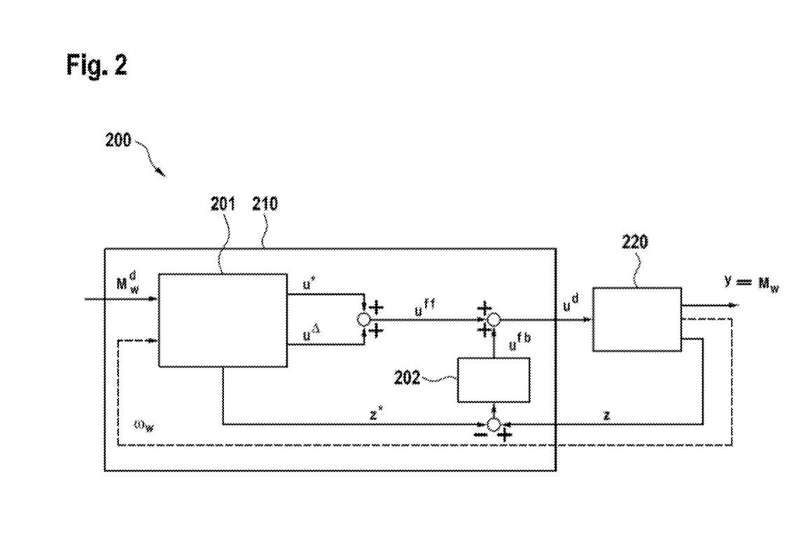

For the purposes of actuating the hydrostatic drive by specifying the manipulated variables, use can be made of a control loop scheme 200, in particular a computer implemented control loop scheme, according to a preferred embodiment of the disclosure, as illustrated schematically in FIG. 2. The control loop scheme has a control member 210 and the controlled system 220.

A driver desired torque M_{w}^{d}, which is supplied to the control member 210, serves as a setpoint variable. The control member is configured to calculate and output a manipulated variable vector u^{d} comprising setpoint values for the adjustment degrees and the driving engine torque u^{d}=[α₁^{d},α₂^{d},Mₘ^{d}] from the driver desired torque M_{w}^{d} and the secondary shaft rotational speed co, fed back from the controlled system 220.

Essentially, this is based on a quasi-static feedforward control by a feedforward control member 201, which is configured to calculate and output a manipulated variable vector of the quasi-static feedforward control u*=[α₁*,α₂*,Mₘ*(Wₘ*)]T from the driver desired torque M_{w}^{d} and the secondary shaft rotational speed ω_{w}.

According to a preferred embodiment of the disclosure, the feedforward control member 201 is furthermore configured to calculate and output a manipulated variable vector u^{Δ} of a dynamic feedforward control from the driver desired torque M_{w}^{d} and the secondary shaft rotational speed (b said manipulated variable vector forming the manipulated variable vector u^{ff} of the feedforward control together with the manipulated variable vector u* of the quasi-static feedforward control. As a result of additionally taking account of a dynamic feedforward control, the response to setpoint changes, i.e. the reaction of the feedback control to a change in the setpoint value, is improved, while the quasi-static component contributes the necessary manipulated variable for the stationary case.

According to a further preferred embodiment of the disclosure, the control member 210 also has a regulating member 202 which is configured to calculate and output a manipulated variable vector u^{fb} of the feedback control from a system deviation between a setpoint state z* and an actual state z comprising high-pressure pₕ and drive rotational speed ωₘ. The manipulated variable vector u^{fb} of the feedback control forms the manipulated variable vector u^{d}=u^{ff}+u^{fb} together with the manipulated variable vector u^{ff} of the feedforward control. This improves the disturbance behavior, i.e. the reaction of the feedback control to disturbances.

A preferred embodiment of a corresponding method is described below with reference to the figures.

### Modeling

A model of the drivetrain that captures the substantially dynamic processes in the system forms the basis of the regulator design. Modeling of the power split drivetrain according to FIG. 1 is considered in an exemplary manner below. The two hydraulic adjuster units 130 and 140 are embodied as axial piston machines of swash plate type construction and are denoted as “AKM1” and “AKM2”, respectively in the following. Their high-pressure-side coupling is modeled as a constant hydraulic volume Vₕ. Hence, the dynamics of the high-pressure emerges as

$$\frac{d}{dt} {p}_{h} = \frac{β}{{V}_{h}} ( {q}_{1} + {q}_{2} ) , \qquad ( 1 )$$

where β is the bulk modulus of the hydraulic liquid and q₁ and q₂ are the volumetric flows of AKM1 and AKM2.

The low-pressure dynamics can be neglected on account of the large volume of the low-pressure reservoir 133. Hence, \dot{p}ₙ≈0 applies and pₙ=0 can be set without loss of generality.

AKM1 and AKM2 are advantageously modeled with losses, as a result of which the volumetric flows qᵢ in (1) and the torques Mᵢ are given in the form

qᵢ=Vᵢωᵢαᵢ−q_{i,v}(αᵢ,pₕ,ωᵢ), (2a)

Mᵢ=Vᵢpₕαᵢ−M_{i,v}(αᵢ,pₕ,ωᵢ), (2b)

where i=1, 2 and Vᵢ is the maximum adjustment volume per radian achieved for the adjustment degree αᵢ=±1.

The volumetric losses q_{i,v} and the hydromechanical losses M_{i,v} of the adjuster units are approximated on the basis of stationary measurements in the form of suitable polynomial ansatz functions of the operating variables adjustment degree αᵢ, pressure pₕ and rotational angle speed ωᵢ.

The kinematics of the drivetrain are modeled in correspondence with the mechanical equivalent circuit diagram according to FIG. 1. The planetary transmission 120 has three connection shafts, wherein the input shaft (left, rotational angle speed ωₘ) is coupled directly to the driving engine 110. The output shafts 121, 122 (right) are coupled by constant transmission ratios i₁ and i_{w} to AKM1 (rotational angle speed ω₁) and the secondary shaft (rotational angle speed ω_{w}), respectively. The kinematic constraint (Willis equation)

i₁ω₁=i₀i_{w}ω_{w}+(1−i₀)ωₘ (3)

describes the coupling between the three connection shafts of the planetary transmission, wherein i₀ denotes the gear ratio between the two output shafts 121, 122 when the input shaft is at rest (ωₘ=0).

If use is made of the two independent rotational angle speeds ωₘ and ω_{w}, it is possible to use (3) to specify the rotational angle speeds of AKM1 and AKM2:

ω₁=i₁ω_{w}+i₁ₘωₘ (4a)

ω₂=i₂ω_{w}, (4b)

with i_{1w}=i_{0iw}/i₁, i₁ₘ=(1−i₀)/i₁ and the transmission ratio 1₂ between AKM2 and secondary shaft 150.

In order to derive the equations of motion, the assumption is made that all rotational inertia of the drivetrain (gear wheels, shafts, drive wheels, etc.) can be reduced into the three moments of inertia Jₘ, J₁ and J_{w} of FIG. 1. The kinetic energy of this system is T=½(mᵥvᵥ²+Jₘωₘ²+J₁ω₁²+J_{w}ω_{w}²), where mᵥ is the vehicle mass and vᵥ=ω_{w}r_{w} (wheel radius r_{w}) is the vehicle speed.

If (4) is taken into account, the equations of motion emerge as

$$[ \begin{matrix}{I}_{m} & {I}_{mw} \\ {I}_{mw} & {I}_{w}\end{matrix} ] \frac{d}{dt} [ \frac{{ω}_{m}}{{ω}_{w}} ] = [ \begin{matrix}{i}_{1 m} {M}_{1} + {M}_{m} \\ {i}_{1 w} {M}_{1} + {i}_{2} {M}_{2} - {M}_{e}\end{matrix} ] , \qquad ( 5 )$$

wherein the positive definite mass matrix on the left-hand side of (5) has the constant entries Iₘ=i₁ₘ²J₁+Jₘ, I_{mw}=i₁ₘi_{1w}J₁ and I_{w}+i_{1w}²J₁+J_{w}+mᵥr_{w}². The generalized forces on the right-hand side of (5) contain the torques M₁ and M₂ of AKM1 and AKM2 according to (2b) and the torque Mₘ of the driving engine 110.

An external force Fₑ that acts on the vehicle center of mass in the longitudinal direction (e.g., air resistance and rolling resistance, downgrade force) is modeled as an external torque Mₑ=r_{w}Fₑ.

The system variable to be regulated is given by the drive torque M_{w}, the setpoint value of which is predetermined by the driver by way of the position of the accelerator pedal (driver desired torque M_{w}^{d}). In order to calculate M_{w}, \dot{ω}ₘ is eliminated from (5) and the following is obtained:

Iₑ\dot{ω}_{w}=M_{w}−Mₑ, (6)

where Iₑ=I_{w}−I_{mw}²/Iₘ is the equivalent moment of inertia, and the drive torque is given by

$${M}_{w} = {i}_{1 w} {M}_{1} + {i}_{2} {M}_{2} - \frac{{I}_{mw}}{{I}_{m}} ( {i}_{1 m} {M}_{1} + {M}_{m} ) . \qquad ( 7 )$$

Taking account of (2) and (4), differential equations (1) and (5) are written in the state space representation

\dot{x}=f(x,u), (8)

with the state x=[pₕ,ωₘ,ω_{w}]^{T}, the input u=[α₁,α₂,Mₘ]^{T} and the output y=M_{w} according to (7) to be regulated.

In the considered system, subordinate regulators are preferably used for the adjustment degree and the drive torque of the motor, which update the input u of (8) according to the desired input u^{d}=[α₁^{d},α₂^{d},Mₘ^{d}]. Here, the desired input u^{d} forms the manipulated variable for the regulation strategy developed below.

By way of example, the dynamics of the subordinate control loops can be approximated by linear models in the time or frequency domain. The manipulated variable limits

u⁻≤u^{d}≤u⁺ (9)

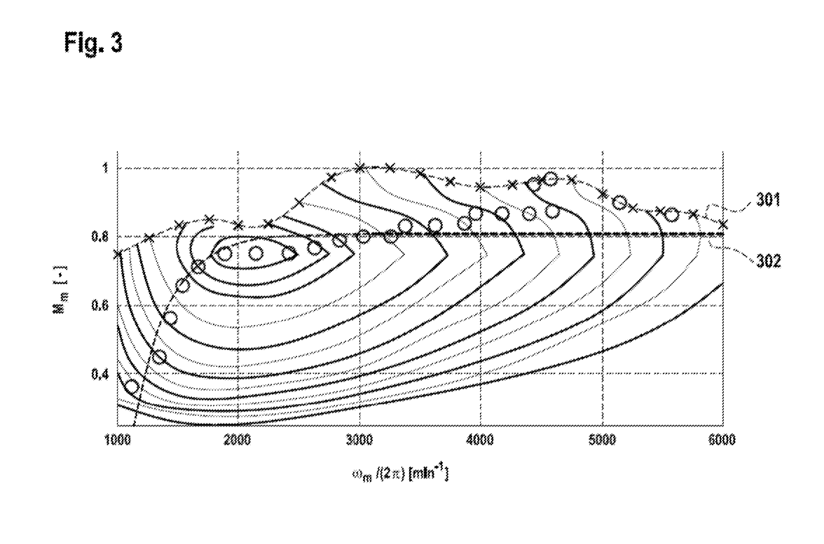

take account of the limit in the adjustment degrees |αᵢ|≤1, i=1, 2 and the torque limit 0≤Mₘ≤Mₘ⁺(ωₘ) of the driving engine 110. Here, the maximum torque of the driving engine 110 is given by the full-load curve Mₘ⁺(ωₘ) thereof; see FIG. 3.

### Generating Ideal Work Points

For a driver desired torque M_{w}^{d} specified at a rotational angle speed co, of the drive shaft 150, the following three nonlinear equations are obtained from the stationary condition 0=f(x,u) of (8) and from taking account of Mₑ=M_{w}=M_{w}^{d} according to (6):

0=i₁ₘ(V₁α₁pₕ+M_{1,v})+Mₘ

0=i_{1w}(V₁α₁pₕ−M_{1,v})+i₂(V₂α₂pₕ−M_{2,v})−M_{w}^{d}

0=V₁α₁ω₁+q_{1,v}+V₂α₂ω₂+q_{2,v}. (10)

Hence, for specified pairs (M_{w}^{d},ω_{w}), two degrees of freedom are available for determining the five unknown variables α₁, α₂, Mₘ, ωₘ and pₕ.

The first of these two degrees of freedom is set by the requirement of operating the driving engine 110 in a stationary fashion on the predetermined operating point characteristic (operation line). Here, the predetermined operating point characteristic is approximated in the form of a functional relationship Mₘ=Mₘ*(ωₘ) in the rotational speed torque map; see FIG. 3.

The remaining degree of freedom is set by virtue of the fact that stationary power loss Pᵥ=Mₘωₘ−M_{w}^{d}ω_{w}, in the hydraulic adjuster units 130, 140 as a consequence of volumetric and mechanical losses is minimized. To this end, the vector w=[pₕ, ωₘ, α₁, α₂]^{T} of the optimization variables is defined and the following optimization problem is solved:

min_{w}Pᵥ=Mₘωₘ−M_{w}^{d}ω_{w} (11a)

with the constraint of (10) and Mₘ=Mₘ*(ωₘ) (11b)

w⁻≤w≤w⁺ (11c)

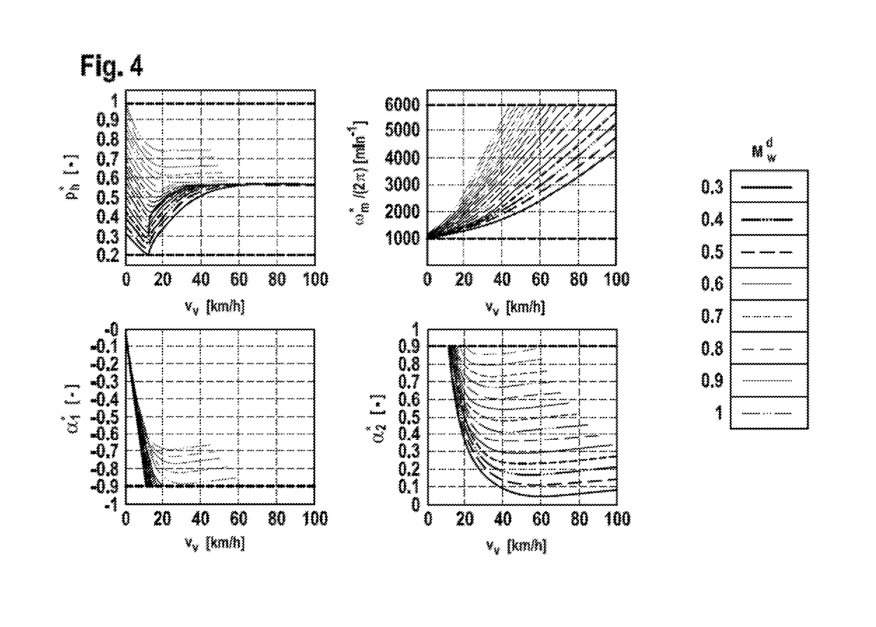

The optimal solution w* of the static optimization problem (11) defines a map of ideal work points for predetermined pairs (M_{w}^{d},ω_{w}); see FIG. 4.

The ideal work points are characterized in that the stationary power loss P, of the hydraulic adjuster units is minimized and the driving engine 110 is operated along the operation line Mₘ=Mₘ*(ωₘ). With the inequality constraints (11c), the admissible operating ranges of the optimization variables are taken into account.

### Multivariable Feedback Control

For the purposes of realizing time-varying torque prescriptions M_{w}^{d}(t), use is preferably made of a MIMO (multiple input multiple output) feedback control strategy according to FIG. 2.

Here, the map

θ*:(M_{w}^{d},ω_{w})→(u*,z*) (12)

determined from the solution of (11) forms the quasi-static feedforward control u*=[α₁*,α₂*,Mₘ*(ωₘ*)]^{T} and the setpoint trajectory z*=[pₕ*,ωₘ*]^{T} for pressure and rotational speed.

An improvement to the response to setpoint changes is obtained by the control law

u^{d}=u*u^{Δ}+u^{fb}, (13)

by means of which the quasi-static feedforward control u* is extended by the component u^{Δ} of a dynamic feedforward control and the component u^{fb} of a stabilizing regulator.

For the regulator design, the dynamics of the subordinate regulators are neglected, as result of which u=u^{d} applies. Moreover, the term I_{mw}\dot{ω}_{w}<<1 in the first line of (5) is neglected and the reduced model

ż=S(z)u−Φ(z,u), (14)

for the regulator design is obtained, with the state z=[pₕ, ωₘ]^{T}, the input u=[α₁, α₂, Mₘ]^{T}, the vector

$$Φ ( z , u ) = [ \frac{β}{{V}_{h}} ( {q}_{1 , v} + {q}_{2 , v} ) , \frac{{i}_{1 m}}{{I}_{m}} {M}_{1 , v} ] , \qquad ( 15 )$$

and the matrix

$$S ( z ) = [ \begin{matrix}- \frac{β}{{V}_{h}} {V}_{1} {ω}_{1} & - \frac{β}{{V}_{h}} {V}_{2} {ω}_{2} & 0 \\ \frac{{i}_{1 m}}{{I}_{m}} {V}_{1} {p}_{h} & 0 & \frac{1}{{I}_{m}}\end{matrix} ] , \qquad ( 16 )$$

With ωᵢ, i=1, 2 according to (4).

The output rotational speed ω_{w} is considered to be an externally predetermined (measurable) variable and, in terms of its dynamics, is not considered in the regulator design.

### Dynamic Feedforward Control

If u=u*+u^{Δ} is inserted into (14),

ż*=S(z*)(u*+u^{Δ})−Φ(z*,u*+u^{Δ}), (17)

is obtained for the dynamic feedforward control u^{Δ}.

With the stationary condition

0=S(z*)u*−Φ(z*,u*), (18)

and the simplification Φ(z*,u*+u^{Δ})≈Φ(z*,u*), the underdetermined linear system of equations

S(z*)u^{Δ}=ż*, (19)

is obtained for calculating u^{Δ}.

The degree of freedom in the selection of u^{Δ} is set on the basis of the solution to the following optimization problem:

$$\begin{matrix}{min}_{{u}^{Δ}} \frac{1}{2} {( {u}^{Δ} - c )}^{T} W ( {u}^{Δ} - c ) & ( 20 a ) \\ with the constraint of S ( {z}^{*} ) {u}^{Δ} = {\dot{z}}^{*} . & ( 20 b )\end{matrix}$$

Which manipulated variables should preferably be used for the dynamic feedforward control can be influenced in a targeted manner by way of the positive definite weighting matrix W in the cost function (20a). Furthermore, c denotes a desired offset of u^{Δ}.

The conditions (19) are taken into account in the form of the linear equation secondary conditions (20b) in the optimization problem. The optimization problem (20) has the optimal solution

$${u}^{Δ} = c + \underbrace{{W}^{- 1} {{S}^{T} ( {SW}^{- 1} {S}^{T} )}^{- 1}}_{{S}^{\#}} ( {\dot{z}}^{*} - Sc ) , \qquad ( 21 )$$

with the weighted pseudoinverse S^{#}=W⁻¹S^{T}(SW⁻¹S^{T})⁻¹ of S=S(z*).

For highly dynamic torque requirements, it may be the case that the optimal solution according to (21) contravenes the constraints

Δ⁻≤u^{Δ}≤Δ⁺ (22)

as a consequence of the manipulated variable limits (9), where Δ⁻=u⁻−u* and Δ⁺=u⁺−u*.

In order to take account of (22) when calculating u^{Δ}, use can be made of e.g. an algorithm that can be found in the literature under the term redistributed pseudoinverse; see, e.g., W. S. Levine. The Control Handbook, Second Edition: Control System Applications. CRC Press, Boca Raton, Fla., 2010.

Here, (21) with c=0 is used if none of the constraints (22) is contravened. Otherwise, i.e., if uᵢ^{Δ}<Δᵢ⁻ or uᵢ^{Δ}>Δᵢ⁺ for i∈{1,2,3}, the offset cᵢ=max{min{uᵢ^{Δ},Δᵢ⁺},Δᵢ⁻} is introduced for c, by means of which the respective manipulated variable is set to its limit. The limited dynamic feedforward control is finally obtained from

u^{Δ}=c+W⁻¹Sᵢ^{T}(SᵢW⁻¹Sᵢ^{T})⁻¹(ż*−Sc), (23)

where Sᵢ denotes a matrix that arises from the i-th column in S being replaced by a zero vector. The weighting matrix is predetermined in diagonal form; i.e., W=diag(W₁^{d},W₂^{d},W₃^{d}), with W₁^{Δ}=W₂^{Δ}=1 and W₃^{Δ}<<1.

### Stabilizing Regulator

With u=u*+u^{Δ}+u^{fb} according to (13), the following error system

ė=S(z*+e)u−Φ(z*+e,u)−ż* (24)

is obtained for the error e=z−z*. Under the assumption of Φ(z*+e,u)≈Φ(z*,u*) and if (18) and (19) are taken into account, the error system (24) simplifies as

ė=Aeu₁^{ff}+S(z*+e)u^{fb}, (25)

with the matrix

$$A = [ \begin{matrix}0 & - \frac{β}{{V}_{h}} {i}_{1 m} {V}_{1} \\ \frac{1}{{I}_{m}} {i}_{1 m} {V}_{1} & 0\end{matrix} ] . \qquad ( 26 )$$

Here, the relationship

S(z*∔e)u=S(z*)u+Aeu₁ (27)

for S according to (16) is taken into account.

On account of the comparatively slow dynamics of the subordinate regulators, a decoupling regulator is not suitable for stabilizing the error system (25). Instead, the stationary relationship e=1/u₁A⁻¹S(z*)u^{fb} between e and e is considered, which is obtained from (25) for ė=0 and taking account of (27). If e=v is required, the relationship

S(z*∔v)u^{fb}=−Avu₁^{ff} (28)

is obtained for determining the regulator component u^{fb}.

Stationary decoupling of the error system is obtained by the prescription v=Kᵢ∫edt−Kₚe, with the diagonal matrices Kᵢ and Kₚ. The entries of these matrices are determined experimentally on the basis of simulation scenarios. In order to ensure sufficient damping of the error system over the entire operating range (see FIG. 4), the weighting of the matrix Kₚ is increased for α₁*→0. In order to fix the degree of freedom when determining u^{fb} from (28), the same algorithm is used as when determining the feedforward control component. The inequality limits to be taken into account are

u⁻−u*−u^{Δ}≤u^{fb}≤u⁺−u*−u^{Δ} (29)

on account of (9) and (13) in this case.

In contrast to the feedforward control, a weighting matrix in diagonal form with the entries W₁^{fb}=W₂^{fb}=1 and W₃^{fb}>>1 is suitable.

FIG. 3 shows a typical torque map, in the form of a rotational speed-torque map, of a combustion engine. The maximum torque is given by the measured data points (x in the figure) of the full-load curve 301. By way of example, the maximum torque M⁺(ωₘ) can be presented analytically by way of cubic splines. Moreover, FIG. 3 shows the typical curve of the operation line 302 of a driving engine 110. The operation line connects work points (o in the figure) in the rotational speed-torque map of the driving engine 110 at which the efficiency for a desired mechanical power Mᵢωₘ (power hyperbolas) is maximized. An approximate representation Mₘ*(ωₘ) of the operation line in analytic form can be effectuated, for example by Mₘ*(ωₘ)=k₀+k₁ tan h(k₂ωₘ−k₃), with suitable parameters kᵢ, i=0, . . . , 3.

FIG. 4 shows maps of the work points defined by the optimal solution of the optimization problem (11) in the case of a normalized representation of pressure pₕ and torque (legend) as a function of the vehicle speed vᵥ=ωᵥr_{w} along the abscissa. The dependence on the driver desired torque M_{w}^{d} is expressed in the different graphs. The limits of the optimization variables illustrated by dashed lines denote the admissible operating ranges of pressure pₕ, rotational speed ωₘ and the two adjustment degrees α₁, α₂. Here, an actuation reserve for the regulator is provided in the shown example by restricting the adjustment degrees to |αᵢ|≤0.9.

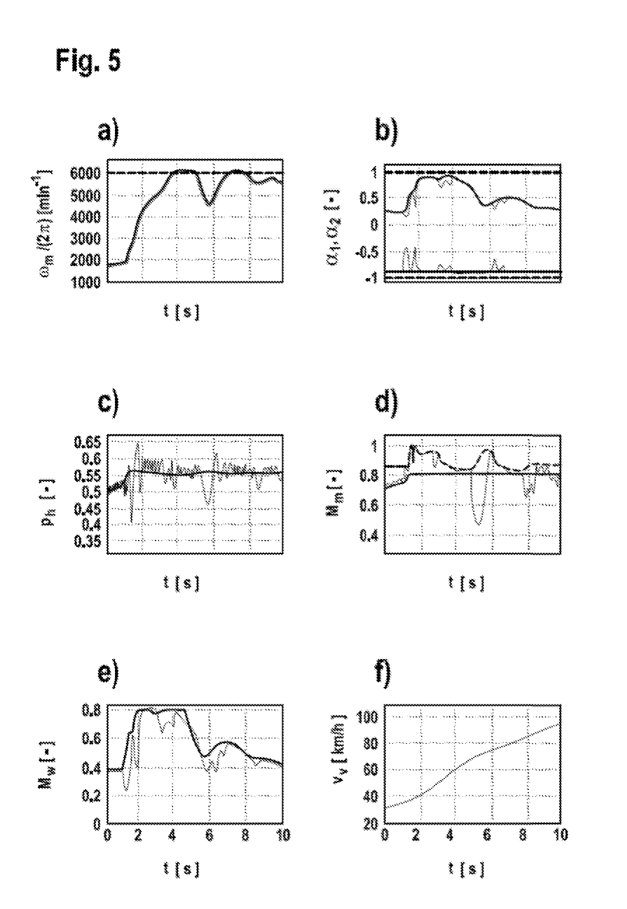

FIG. 5 shows simulated graphs for illustrating an acceleration process of a drivetrain actuated according to a preferred embodiment of the disclosure, with a normalized illustration of pressure pₕ, drive torque M_{w} and torque Mₘ of the driving engine 110.

In detail, FIG. 5a shows the curve of the rotational speed ωₘ of the driving engine, FIG. 5b shows adjustment degrees α₁ (bottom, smaller than zero) and α₂ (top, greater than zero), FIG. 5b shows the normalized high pressure pₕ, FIG. 5d shows the torque Mₘ of the driving engine 110, FIG. 5e shows the drive torque M_{w} and FIG. 5f shows the driving speed vᵥ.

Here, FIGS. 5a, 5c and 5e plot setpoint values (thick line) and simulated (actual) values (thin line), in each case over time t. FIG. 5f only shows simulated (actual) values since no setpoint values exist for the driving speed. In FIGS. 5b and 5d, setpoint values emerging from the purely quasi-static feedforward control u* are denoted by thick lines and setpoint values emerging overall (u^{d}) from the feedforward control and the regulation are denoted by thin lines. Limits that are present are denoted by dashed lines.

In order to examine a realistic scenario, sensors for the rotational speeds and the pressure in the simulation had noise applied thereto. In order to exhibit the robustness of the feedback control strategy, the losses of the adjuster units are simulated with deviations from the nominal value of up to 30%. Taking account of the manipulated variable constraints in the dynamic feedforward control guarantees very good stabilization of the pressure at the setpoint value, even in the case of high accelerations of the driving engine 110, in which the maximum torque is typically demanded.

It is clear from FIG. 5a that the rotational speed ωₙ, of the driving engine directly follows the setpoint value in the simulation.

The observed control error in the output torque M_{w} in FIG. 5e is mainly due to the system and cannot, as a matter of principle, be compensated by the feedback control. On the one hand, an abrupt increase in the output torque requires such a strong acceleration of the driving machine 110 that, briefly, a considerable part of the power fed in is applied to accelerate the driving machine 110, thus having a slump in the output torque as a consequence. On the other hand, the power of the driving machine 110 is restricted by the maximum admissible rotational speed (e.g., 6000 min⁻¹ in FIG. 5a). If the demanded power exceeds the maximum power, the output torque deviates from the setpoint value, even in the case of a constant curve of the driver desired torque.

What is claimed is:

1. A method for controlling a hydrostatic drive, which has a driving engine, a hydraulic pump coupled to the driving engine, and a hydraulic motor coupled to the hydraulic pump by way of a pressurized hydraulic work line, the method comprising:
calculating a manipulated variable vector comprising at least one manipulated variable for the hydrostatic drive based on (i) an output torque setpoint value for a torque on a secondary shaft driven by the hydraulic motor, the secondary shaft rotating at a secondary shaft rotational speed, (ii) a rotational speed and torque of the driving engine emerging from a predetermined operating point characteristic for the driving engine, and (iii) volumetric and mechanical losses of at least one adjuster unit comprising the hydraulic pump and the hydraulic motor; and
using the calculated manipulated variable vector to control the hydrostatic drive.

2. The method according to claim 1, further comprising:
calculating the manipulated variable vector based further on at least one manipulated variable constraint of the at least one manipulated variable.

3. The method according to claim 1, further comprising:
determining a static feedforward control component of the calculated manipulated variable vector by solving an optimization problem for minimizing a stationary power loss as a consequence of the volumetric and mechanical losses of the at least one adjuster unit while maintaining the rotational speed and torque of the driving engine emerging from the predetermined operating point characteristic for the driving engine.

4. The method according to claim 3, further comprising:
determining a characteristic map by solving the optimization problem depending on the output torque setpoint value and on the secondary shaft rotational speed,
wherein the characteristic map has a number of work points.

5. The method according to claim 1, further comprising:
determining a dynamic feedforward control component of the calculated manipulated variable vector depending on a temporal change of a setpoint state based on a pressure in the pressurized hydraulic work line and/or the secondary shaft rotational speed of the secondary shaft.

6. The method according to claim 5, wherein the manipulated variable vector has a regulator component, which compensates system deviations between the setpoint state and an actual state that is based on the pressure in the pressurized hydraulic work line and/or the secondary shaft rotational speed of the secondary shaft.

7. The method according to claim 6, further comprising:
determining the regulator component based on a specification of a desired error dynamics with suitable regulator parameters.

8. The method according to claim 1, wherein the predetermined operating point characteristic is predetermined based on a line of optimal efficiencies and/or depending on a full-load curve.

9. The method according to claim 1, wherein the at least one manipulated variable for the hydrostatic drive comprises a manipulated variable that influences a transmission ratio between the hydraulic pump and the hydraulic motor and/or the torque of the driving engine.

10. The method according to claim 9, wherein the at least one manipulated variable influencing the transmission ratio between the hydraulic pump and the hydraulic motor comprises an adjustable volume of the at least one adjuster unit.

11. The method according to claim 1, further comprising:
ascertaining the volumetric and the mechanical losses of the at least one adjuster unit based on stationary measurements in the form of polynomial ansatz functions depending on a pressure in the pressurized hydraulic work line, an adjustment degree, and a rotational angle speed of the at least one adjuster unit.

12. The method according to claim 1, wherein the hydrostatic drive has a power-split transmission with a mechanical power branch and/or a travel drive.

13. The method according to claim 1, wherein a computational unit carries out the method.

14. The method according to claim 13, wherein a computer program prompts the computational unit to carry out the method when the computer program is executed on the computational unit.

15. The method according to claim 14, wherein a machine-readable storage medium has the computer program stored thereon.
